(19) United States
(12) Patent Application Publication
(10) Pub. No.: US 2014/0042230 A1
(43) Pub. Date: Feb. 13, 2014

(54) CHIP CARD MODULE WITH SEPARATE ANTENNA AND CHIP CARD INLAY USING SAME

(71) Applicants: Frank Pueschner, Kelheim (DE); Juergen Hoegerl, Regensburg (DE)

(72) Inventors: Frank Pueschner, Kelheim (DE); Juergen Hoegerl, Regensburg (DE)

(73) Assignee: INFINEON TECHNOLOGIES AG, Neubiberg (DE)

(21) Appl. No.: 13/570,291

(22) Filed: Aug. 9, 2012

(51) Int. Cl. G06K 19/077; H01P 11/00

(52) U.S. Cl. 235/492; 29/600

(57) ABSTRACT

A chip card module is disclosed. The module includes an antenna carrier defining an antenna layer with at least one antenna disposed on a surface of the antenna carrier. A chip package defines a package layer different from the antenna layer in that the chip package encapsulates an integrated circuit chip packaged separately from the antenna layer. The chip package is attached to the antenna carrier and electrically connected to the antenna, forming a laminated structure.

### TECHNICAL FIELD

Various aspects of the disclosure relate generally to chip card technology, and more particularly to chip card modules and antennas therefor.

### BACKGROUND

Chip cards including chip card modules with integrated antennas for chip card applications are constructed such that the antenna is an integrated component of the module. An advantage of such construction can be that chip card antennas for wireless chip cards do not require mechanical connection to the package but rather that a connection between a chip or package and the card antenna may be achieved between the package antenna and a booster antenna without a direct connection therebetween. In such a case, interface between the package antenna and booster antenna may be achieved through adjustment of a resonant interface between the antennas. Establishing such resonance may be a question of the dimensions and size of the package antenna.

In such a case, the chip must be protected from mechanical stresses, such as those induced by banding or pressure, in order to achieve a high level of robustness and to minimize signal loss. A solution has been to provide a laminated material system using materials having properties specifically selected for this purpose. As chip sizes have been reduced, along with module and package sizes, the high costs of the material system, are also sought to be reduced.

The interface between package antenna and booster antenna is dependent upon the footprint of the antennas, with the result that further reduction in the chip card/antenna package size may be limited. Accordingly, further reductions in the use of materials in protection of the chip package may likewise be limited.

### SUMMARY

A chip card module is disclosed having, for example, an antenna housed on a protective structure and a component in a separate protective structure. The protective structure of the component may be attached to the protective structure of the antenna. This forms a module wherein the protective structure of the component is not dependent upon the surface area of the antenna. More particularly, the protective structure of the component may have a smaller surface area than the antenna(s).

The antenna protective structure may be made of a thin, flexible antenna carrier material. In a case where the component is a semiconductor chip the chip's protective structure may be a package including a chip cover and a substrate layer with the chip encapsulated between them.

The antenna may have two coils, the first may be disposed on one side of the antenna carrier, and the second on the other side. The coils may be electrically connected to each other. The coils may themselves be metallizations formed on the surface of the antenna carrier. The antenna carrier may have a modulus of elasticity greater than that of said first and second coils.

The antenna carrier may have a plurality of further chip card modules disposed thereon. In such a case, the antenna carrier may be a carrier strip holding at least a plurality of further antenna coils, or antenna coil pairs.

A card inlay is also described that may include a substrate having a top surface and may have a main antenna coil and a booster antenna coil connected to said main antenna coil. A cavity may be formed in a surface of the substrate, for example, proximal to the booster antenna coil. The cavity may be sized to receive a chip card module that is inductively coupled to the booster antenna coil when inserted within the cavity.

The protective structure of a chip card module may be recessed within the cavity and at least one module antenna coil and an antenna carrier may be positioned above the top surface. Alternately, the chip card module may be completely recessed within the cavity, and cover foil may be provided over a surface of the substrate.

Manufacturing a card inlay is disclosed including for example, cutting out a chip card module from a module carrier, inserting the chip card module into a card inlay blank, and/or flipping the chip card module and inserting the semiconductor chip protective structure first into said cavity, and covering the top and/or surface with foil.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various aspects of the disclosure are described with reference to the following drawings, in which:

FIG. 1a shows a carrier strip with a plurality of chip card modules;

FIG. 1b shows an exploded view of a chip card module including a CIS package;

FIG. 1c shows an exploded view of a CIS package including a chip;

FIG. 2 illustrates a chip card inlay and a method for manufacturing the same.

FIG. 3 shows a cross-section of an embodiment according to the present disclosure.

FIG. 4 shows a cross-section of an embodiment according to the present disclosure.

### DETAILED DESCRIPTION

The following detailed description refers to the accompanying drawings that show, by way of illustration specific details and aspects of the disclosure in which the aspects of the disclosure may be practiced. These aspects of the disclosure are described in sufficient detail to enable those skilled in the art to practice it. Other aspects of the disclosure may be utilized and structural, logical and electrical changes may be made without departing from the scope of the disclosure. The various aspects of the disclosure are not necessarily mutually exclusive, as some aspects of the disclosure can be combined with one or more other aspects of the disclosure to form new aspects of the disclosure. The following detailed description therefore is not to be taken in a limiting sense, and the scope of the present disclosure is defined by the appended claims.

Various aspects of the disclosure are provided for devices and various aspects of the disclosure are provided for methods. It will be understood that basic properties of the devices also hold for the methods and vice versa. Therefore, for the sake of brevity duplicate description of such properties may be omitted.

The term “at least one” as used herein may be understood to include any integer number greater than or equal to one.

The term “a plurality of” as used herein may be understood to include any integer number greater than or equal to two.

The terms “coupling” or “connection” as used herein may be understood to include a direct “coupling” or direct “connection” as well as an indirect “coupling” or indirect “connection”, or attachment respectively. Likewise, “attached” may indicate a physical attachment, or may include an electrical or other functional coupling.

The term “major surface” used interchangeably with “top side” and “bottom side” or simply “side” or “first” and “second” side such as of a tape-like or card-like substrate is meant to indicate the two surfaces of such structure having substantially more surface area than the side surfaces extending across the thickness of the substrate.

The term “protective housing” or “protective structure” as used herein in connection with a component is intended to include any structure that secures the component within or on it. In this sense, a housing may provide lateral or subjacent support for the component, or may partially or completely surround the component.

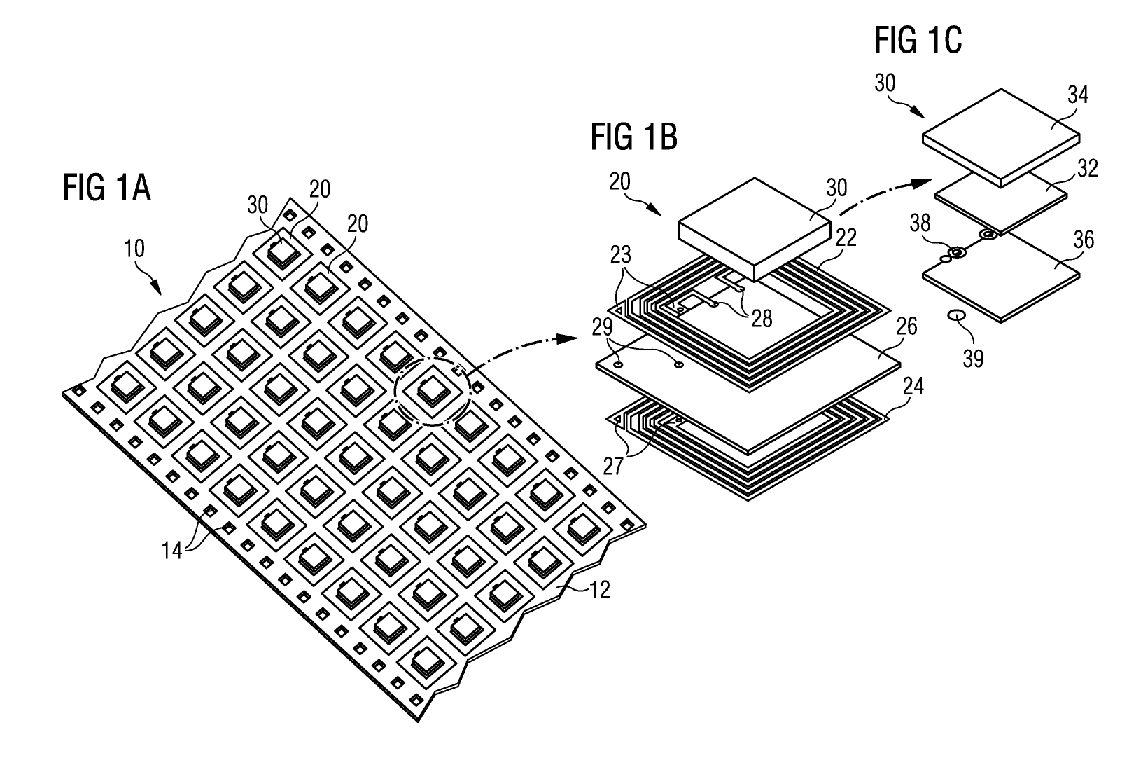

FIGS. 1A-1C illustrate an aspect of the present disclosure. In particular, FIG. 1A shows module carrier 10 having a plurality of chip card modules 20 disposed thereon. As shown, module carrier 10 is formed of a carrier strip, shown as a thin, film-like material. Advantageously, carrier strip 12 may be provided with automatic-feed perforations 14.

During manufacturing, storage and use of module carrier 10, carrier strip 12 may function variably to facilitate efficient storage of chip card modules 20, to position modules 20 for processing, to protect the components of modules 20 from damage, and to provide traction for accurate feeding during use, such as in a pick-and-place apparatus. Advantageously, in support of one or more of the above functions, carrier strip 12 may be flexible and have a sufficient tensile strength and stiffness to protect the structures thereon from damage during manufacturing, shipping, storage and use of module carrier 10. Examples of suitable materials may include Polyimide, PET, PEN, Epoxy glass-fiber reinforced.

As shown in FIG. 1A, carrier strip 12 may be provided in a strip format, e.g. having a standard dimension of 35 millimeters and may include perforations 14. Carrier strip 12 may be sufficiently flexible to permit the strips to be stored in a roll format both after formation of antenna structures 22 and 24 thereon and after mounting of CIS [chip-in-substrate?] packages 30 to the carrier strip, and electrically connecting CIS package 30 to antennas 22 and 24. Perforations 14 may therefore aid in feeding carrier strip 12 such as for use in production of finished chip cards.

FIG. 1B shows in exploded form an exemplary construction of module 20 according to an aspect of the disclosure. In particular, module 20 includes CIS package 30 and antenna carrier 26. Top and bottom antenna 22 and 24, respectively, are formed on respective sides of antenna carrier 26. Advantageously, antenna carrier 26 may be formed of the same material as the carrier strip. As shown, antenna carrier 26 may itself be formed of a portion of carrier strip 12, separated from module carrier 10 upon removal of module 20 from module carrier 10.

In use, antenna carrier 26 provides a substrate for support of top and bottom antennas 22 and 24, as well as for CIS package 30. In particular, antennas 22 and 24 may be formed of copper or aluminum, e.g. using an appropriate etch technology. Accordingly, antenna carrier 26 may advantageously be selected from an electrically insulating material including one or more plastics or similar synthetic substances. To the extent that carrier strip 12 is formed of the same material as antenna carrier 26, portions of carrier strip 12 or may serve as antenna carrier 26, said antenna carrier being cut from the carrier strip material on which respective antennas 22 and 24 are formed.

The metallic structures of antennas 22 and 24 are shown as a spiral or coil-structured metallization formed directly on antenna carrier 26. Where antennas 22 and 24 have a minimum effective thickness, and where the width of the metallization forming the coil configuration is also minimized, the antenna structures may be particularly sensitive to in-plane distortion.

For example, the antennas formed on antenna carrier 26 would be particularly susceptible to damage due to stretching of the antenna carrier along its length or width. Accordingly, antenna carrier 26 may in such a case advantageously be selected from materials having appropriately high tensile-strength and/or high elastic modulus (stiffness). In at least one embodiment, antenna carrier 26 is selected to have an elastic modulus higher than the coils formed on antenna carrier 26.

To the extent that flexibility is desired in carrier strip 12 (such as for efficient storage of module carrier 10) or in antenna carrier 26 (due to flexing expected when employed in a chip card), carrier strip 12/antenna carrier 26 are also advantageously selected from materials that retain their strength and stiffness even when provided in a thin format. Advantageously, a thin format carrier strip 12/antenna carrier 26 would tend to reduce surface stresses during flexing that could damage the antenna structures 22 and 24.

CIS package 30 is electrically connected to top antenna 22 at electrical contacts 28 thereof. Through contacts 29 are provided to establish contact between top antenna 22 and bottom antenna 24 through antenna carrier 26. As shown, antenna contacts 23 in top antenna 22 are aligned with antenna contacts 27 in bottom antenna 24, through contacts 29 advantageously disposed therebetween.

CIS package 30 is shown in an exploded view in FIG. 1C. According to an aspect of the present disclosure, chip 32 which is generally understood to be a semiconductor chip having a plurality of circuit components formed thereon, is shown sandwiched between chip cover 34 and substrate layer 36. As shown, chip cover 34 and substrate layer 36 have dimensions sufficient to encapsulate chip 32. Chip cover 34 and substrate layer 36 may be formed respectively of e.g. Epoxy resin with integrated filler like SiO2 for Chip Cover 34 and Epoxy with glass fiber enforcement as used at PCB (Printed Circuit Board Production for substrate layer 34 and Chip cover 34). They are significantly more rigid than the antenna carrier due to filler/glass fiber re-enforcement. Some of the above mentioned materials are significantly more expensive but therefore enables the CIS package to be more robust than the material used for the antenna carrier. For example, in the prior unitary construction, in which the antenna and chip were encapsulated together, a single expensive material was utilized. Moreover, due to the smaller size of CIS package 30, very rigid material can be advantageously employed to add robustness and to minimize CIS package size. Top metallization 38 and bottom metallization 39 are provided on respective sites of substrate layer 36 and are advantageously electrically connected to each other through substrate layer 36. Top metallization 38 selectively establishes electrical contact with chip 32 thereby providing electrical contact between chip 32 and bottom metallization 39.

Metallization 39 may advantageously be configured to align with contacts 28 of top antenna 22 position on antenna carrier 26. As assembled, module 20 provides electrical contact from bottom antenna 24 through provisions 29 through to top antenna 22. Connection between contacts 28 of top antenna 22 and bottom metallization 39 of CIS package 30 may establish contact between chip 32 and both top antenna 22 and bottom antenna 24. Alternatively, contact between bottom antenna 24 and/or top antenna 22 and/or CIS package 30 may be established by direct electrical connection as described herein, or may be established through other means, including but not limited to inductive coupling.

As antenna carrier 26 serves in part to provide physical protection to the antenna structures formed thereon, CIS package 30, as described herein serves, among other functions, to provide physical protection to chip 32. In particular, it will be recognized by a person of skill in the art that chip 32 is susceptible to damage from different environmental conditions, and to different degrees than the antennas 22 and 24. For example, the microelectronics on chip 32 may have relatively high sensitivity to abrasion, static-electric discharge, and may be relatively less flexible than the antennas 22 and 24. Accordingly, chip cover 34 and substrate layer 36 may be specifically designed to harden CIS package 30 against influences that would otherwise damage chip 32.

As noted above, factors limiting future reduction in the size of chip 32 may differ from factors limiting reduction in the footprint of antennas 22 and 24. Accordingly, technical advances in chip design leading to a reduction in chip size may not occur simultaneously with technical advances allowing for smaller antenna area and therefore an overall reduction in the size of module 20. In particular, reductions in chip size have resulted in typical CIS packages having significantly smaller minimum dimensions than the minimum surface area required for an antenna in a typical chip card application. Where this is the case, antenna dimensions define the size of antenna carrier 26 with the result that the bulk of the area occupied by module 20 and supported by antenna carrier 26 is a function of antenna size. Absent advances in antenna technology (or chip card reader sensitivity) overall reductions in module size in the example shown in the present disclosure would be limited by antenna physics, and the radio-frequency specifications of the wireless technology employed.

It will be apparent to a person of skill in the art, however, that opposing scenarios may also present depending upon the technology employed. For example, it may be the case that considerations other than minimum antenna size may dictate the configuration of module 20. For purposes of this disclosure, it may be the case that the form factor of module 20 is defined by industry standards, or that a limiting factor may be the proper positioning of CIS package 30 on antenna carrier 26, rather than the relative footprints of antenna vs. chip. In fact, any limitation on one component of package 20 that does not necessarily apply equally to other components would fall within the scope of this disclosure.

To the extent that the embodiment shown in FIGS. 1a-1c are illustrated by example, reductions in manufacturing overhead that might have been achieved through reductions in the size of module 20, for example allowing a greater number of modules to be placed on the same size carrier strip, can instead be achieved by reducing the costs of material used for carrier strip 12. To the extent that this selection is informed only by the design requirements of antennas 22 and 24, any material suitable for supporting the antenna structures and providing the requisite robustness would be suitable.

By contrast, again within the example illustrated in FIGS. 1a-c, although semiconductor manufacturing technology has yielded progressively smaller chip sizes, semiconductor chips such as chip 32 are particularly sensitive to environmental influences. Accordingly, chips have grown smaller at a rate not necessarily consistent with an increase in robustness. For this reason, CIS package 30 includes chip cover 34 and substrate layer 36 specifically selected to protect the relatively delicate circuitry of chip 32 when compared to that of antennas 22 and 24.

For this reason, there may be considerably less flexibility in choosing inexpensive materials for chip cover 34 or substrate layer 36. In any case, a smaller chip would be expected to require less of any relatively expensive material to protect it. Accordingly, the aspect of the disclosure shown in FIGS. 1a-c decouples design considerations affecting antenna robustness from those considerations uniquely applicable to chip 32. According to an example of this decoupling in the embodiment shown, relatively expensive materials used for chip cover 34 and substrate layer 36 can be limited to the chip itself whereas antenna carrier 26 can be selected from a wider range of materials that would not be suitable or adequate alone to protect chip 32.

It will be understood that cost is not the only factor in selecting the antenna carrier and CIS package materials. Flexibility, strength, chemical and temperature resistance may all be taken into consideration. Regardless of design considerations, however, the present disclosure allows for chip specific design requirements to be treated separately from those affecting antenna construction with the result that an overall improvement in robustness of module 20, a decrease in costs, or an improvement in dimensions such as thinness can be accomplished. Likewise, CIS package 30 may be manufactured separately from the antenna such as in different processes informed by different manufacturing requirements. This result may also contribute to cost or time savings.

In a manner consistent with the disclosure of the chip card module described above, the chip card module 20 takes the form of a laminated structure wherein the antenna carrier defines an antenna layer, and the CIS package defines a package layer different from the antenna layer. Each layer in the laminate structure may be independently designed and implemented. Changes to one layer, such as in response to advances in technology, or changes in manufacturing or performance specifications have minimal effect on the other layer.

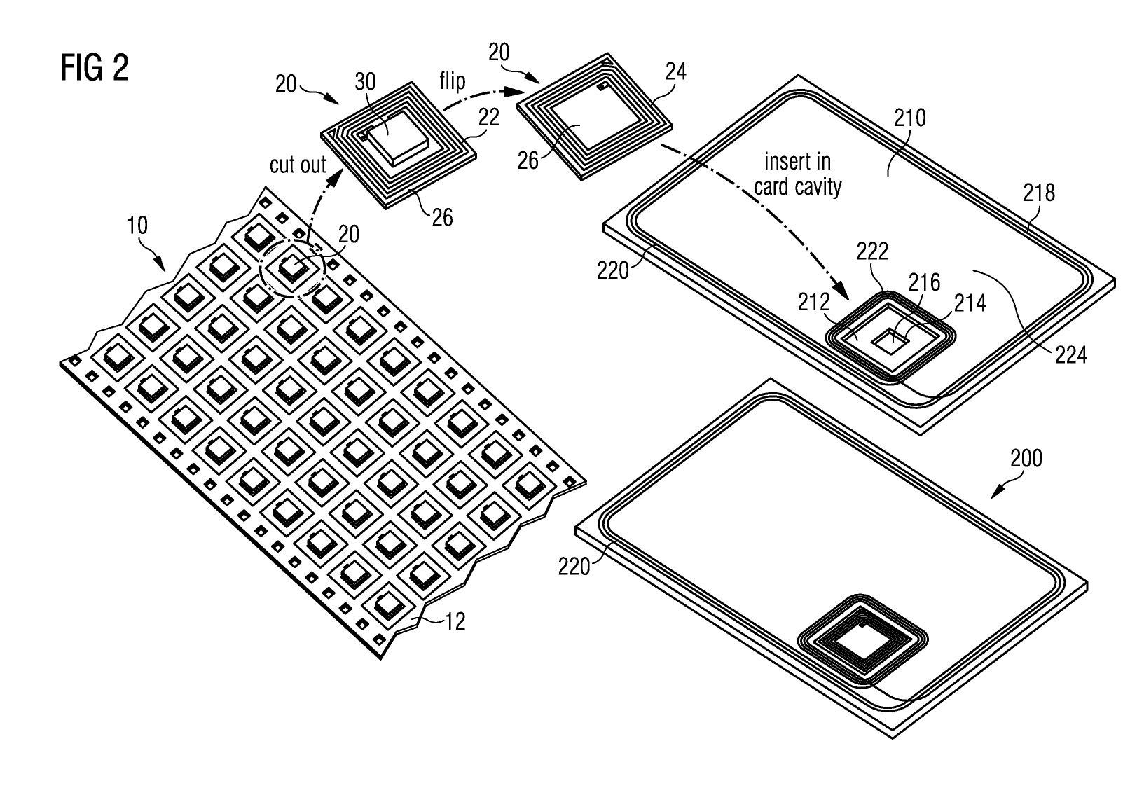

FIG. 2 illustrates a method for manufacturing a chip card 200 according to an aspect of the present disclosure. As shown FIG. 1, carrier strip 12 is shown in FIG. 2 having a plurality of chip card modules 20 disposed thereon. Each of chip card modules 20 likewise includes a top antenna 22, a bottom antenna 24 formed on carrier strip 12 and a CIS package 30 connected to the antennas and mounted on the carrier strip.

Each of said modules 20 are spaced from adjacent modules on carrier strip 12 such that they may be cut out of carrier strip 12 forming a module 20 including one pair of top and bottom antennas 22 and 24 mounted to or formed on antenna carrier 26. Antenna carrier 26 may be formed of a portion of carrier strip 12, and a CIS package 30 connected, e.g. to top antenna 22 as shown. Module 20 may then be flipped 180° with the result that bottom antenna 24 is facing upward and CIS package 30 is facing downward.

A card inlay blank 210 may be provided having card cavity 212. Card inlay blank 210 is typically dimensioned similarly to a standard credit card and may be made of similar materials. Card cavity 212 may be a recessed portion of card inlay blank 210, wherein the recess is similar in length, width and/or depth to that of module 20. More particularly, card cavity 212 may have a depth that corresponds to the topology of module 20, e.g. with an outer recess area 214 having a depth sufficient to receive antenna carrier 26 (as well as antennas 22 and 24), and a more deeply recessed portion 216 which provides sufficient space for both antenna carrier 26 and CIS package 30 mounted thereon.

Card inlay blank 210 may be provided with booster antenna 220, a typical booster antenna being formed of an outer loop 218 and an inner loop 222. Alternatively, outer loop 218 may be called the main antenna, to distinguish its function from that of inner loop 222, which functions to couple main antenna loop 218 to antennas 22 and 24 of chip card module 20. Where inner loop 222 is configured to be inductively coupled to the antennas of a chip card module, inner loop 222 may advantageously be disposed around the circumference of card cavity 212. Outer loop 218, by contrast may be found along this circumference of card inlay blank 210, outer loop 218 typically providing contactless coupling with a card reader, for example.

In assembling completed chip card 200, the inverted chip card module 20 is inserted within card cavity 2012. Depending upon the depth of recesses 214 and 216, the surface of bottom antenna 24 and the exposed portion of antenna carrier 26 may be flush with the surface 224 of card inlay blank 210.

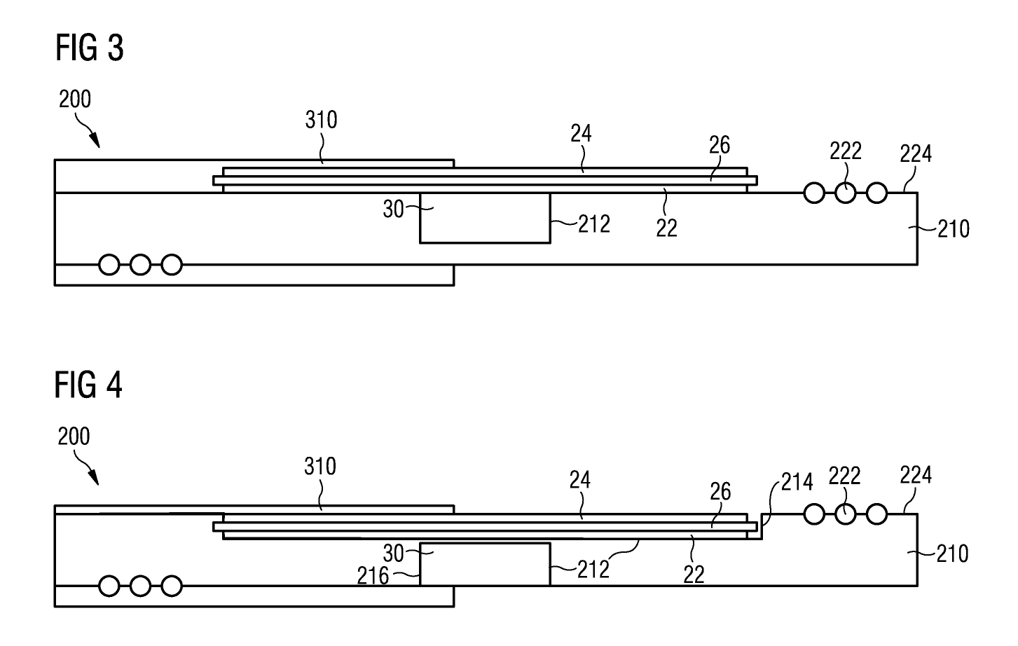

FIGS. 3 and 4 disclose further embodiments of the chip card of the present disclosure. In particular, FIG. 3 shows a cross section of a portion of card inlay blank 210 which forms the completed chip card inlay 200. FIG. 3 illustrates a card cavity 212 that is sufficient to receive CIS package 30. Top antenna 22, antenna carrier 26 and bottom antenna 24 are shown supported directly by the top surface 224 of card inlay blank 210. By contrast, FIG. 4 illustrates a two-tiered card cavity such as that disclosed in FIG. 2 wherein CIS package 30 is recessed within portion 216 of cavity 212 whereas top antenna 22, antenna carrier 26 and bottom antenna 24 are likewise recessed within card inlay blank 210 with the result that bottom antenna 24 is flush with top surface 224 of card inlay blank 210.

Both the embodiment of FIG. 3 and the embodiment of FIG. 4 provide that the inlay may be embedded or exposed, and that a cover foil may be provided over relatively sensitive components such as module antennas 22 and 24. Moreover, booster antenna 222 is shown on both the same and opposite site of the module antennas 22 and 24. Completed inlays 200 encompass the working components of e.g. a contactless chip card system wherein, during operation, communication with chip 32 can be achieved by placing booster antenna 220 within an electromagnetic field. In particular, the electromagnetic field may be selectively generated by a card reading apparatus, the electromagnetic field inducing an electric current in booster antenna 220, the electric current, e.g. comprising a signal transmitted to module 20 via inductive interface between a booster antenna 220 and one or both of top antenna 22 and bottom antenna 24 of chip card module 20. The signal received by module antennas 22 and 24 both power chip 32 and carried data signals to it within CIS package 30 through metal contacts 38 and 39. Thus powered, chip 32 may respond to the data signal received and may return transmission through module antennas 22 and 24 to booster antenna 220. These signals transmitted by chip 32 may then be received by a chip card reader.

As inlay 200 may itself form the completed chip card, or may instead be housed within further layers before taking the form, e.g. of an ID1-format chip card. The dual packaging structure of the afore-described embodiments and aspects of the disclosure permits and antenna carrier 26 to be specifically designed for protection of module antennas 22 and 24. For example, in the event that inlay 200 is housed within an ID1-format chip card, module antennas 22 and 24 may be suitably protected and robustly flexible using an antenna carrier 26 formed of materials that do not necessarily address specific robustness issues presented by chip 32. Likewise, where chip 32 is protectively housed between chip cover 34 and substrate layer 36, CIS package 30 can be dimensioned without consideration of the area occupied by module antennas 22 and 24. The decoupling of protective structures in this manner permit economical and efficient selection of materials for each set of design requirements, chip 32 within CIS package 30 nearly being supported by antenna carrier 26 and not necessarily protected by it.

In an alternative embodiment, CIS package 30 may optionally be positioned beneath bottom antenna 24, thereby eliminating the need to flip module 20 prior to insertion within card cavity 212 of card inlay blank 210.

In a further alternate embodiment CIS package 30 may be positioned midway between module antennas 22 and 24, with the result that CIS package 30 does not rest directly on antenna carrier 26 but is recessed partway within it. In such a configuration, the flipping of module 20 prior to insertion in card cavity 212 of card inlay 210 would be optional, and module 20 may itself have a total thickness that is reduced.

In a further alternate embodiment, the module antennas 22 and 24 of module 20 may be designed to occupy a larger area on carrier strip 12, conceivably occupying sufficient area such that direct communication between a chip mounted on module 20 and a card reader may be accomplished without a booster antenna. As noted above, the decoupling of material considerations between antenna and chip enable the use of material specifically designed to provide the flexibility and robustness of the antenna structure without regard to the specific robustness requirements presented by chip 32, for example. In such an embodiment, carrier strip 12 could conceivably function as a card inlay in its own right.

A person skilled in the art will recognize that the combinations of the above exemplary embodiments may be formed. While the invention has been particularly shown and described with reference to specific aspects of the disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalent see of the claims are therefore intended to be embraced.

What is claimed is:

1. A chip card module comprising:
an antenna component having a first dimensional area;
a second component;
a first protective structure associated with the antenna component, and
a second protective structure attached to the first protective structure, the second protective structure associated with the second component,
wherein the second protective structure is independent of the first dimensional area.

2. The chip card module of claim 1, wherein the first protective structure comprises an antenna carrier formed of a thin, flexible material.

3. The chip card module of claim 2, wherein the second component is a semiconductor chip.

4. The chip card module of claim 3, wherein the second protective structure is a package comprising a chip cover and a substrate layer, the chip being encapsulated therebetween.

5. The chip card module of claim 2, wherein the antenna component comprises:
a first coil disposed on a first major surface of the antenna carrier, and
a second coil disposed on a second major surface of the antenna carrier,
wherein said first and second coils are electrically connected to each other.

6. The chip card module of claim 5, wherein said coils are metallizations formed on the surface of the antenna carrier.

7. The chip card module of claim 6, wherein the antenna carrier has a modulus of elasticity greater than that of said first and second coils.

8. The chip card module of claim 2, wherein the antenna carrier comprises a carrier strip, the carrier strip having a plurality of further chip card modules disposed thereon.

9. The chip card module of claim 2, wherein the antenna carrier comprises a carrier strip, the carrier strip having a plurality of further antenna coils disposed thereon.

10. The chip card module of claim 3, wherein the second protective structure has a second dimensional area, wherein the second dimensional area is smaller than the first dimensional area.

11. A card inlay comprising:
a substrate having a top surface, a main antenna coil and a booster antenna coil connected to said main antenna coil;
a cavity formed in said top surface of the substrate proximal to said booster antenna coil;
a chip card module comprising:
an antenna carrier formed of a thin flexible material;
at least one module antenna coil formed on said antenna carrier;
a protective structure for a semiconductor chip, the protective structure encapsulating said semiconductor chip;
wherein at least a portion of said chip card module is recessed within said cavity, the at least one module antenna inductively coupled to said booster antenna coil.

12. The card inlay of claim 11, wherein said protective structure of said chip card module is recessed within said cavity, and wherein said at least one module antenna coil and said antenna carrier are positioned above said top surface.

13. The card inlay of claim 11, wherein the chip card module is completely recessed within said cavity.

14. The card inlay of claim 13, wherein a cover foil is provided over said top surface and the chip card module.

15. A method of manufacturing a card inlay, the method comprising:
cutting out a chip card module from a module carrier, the module carrier comprising:
a carrier strip;
a plurality of antenna components positioned on said carrier strip; and
a plurality of protective structures attached to said carrier strip and connected respectively to said plurality of antenna components,
wherein each of the protective structures encapsulates a semiconductor chip;
inserting the chip card module into a card inlay blank, the card inlay blank comprising:
a substrate having a top surface and a booster antenna coil; and
a cavity formed in said top surface of the substrate proximal to said booster antenna coil.

16. The method of claim 15, further comprising covering the top surface with foil.

17. The method of claim 15 further comprising flipping the chip card module, inserting the semiconductor chip protective structure first into said cavity.

18. The method of claim 17 wherein inserting the chip card module establishes an inductive coupling between said antenna components and said booster antenna coil.

19. The method of claim 18 further comprising covering a bottom surface of said card inlay blank with foil.

20. A chip card module comprising:
an antenna carrier defining an antenna layer;
a first antenna disposed on a first major surface of the antenna carrier;
a chip package defining a package layer different from said antenna layer, the chip package encapsulating an integrated circuit chip;
wherein the chip package is attached to the antenna carrier and electrically connected to said first antenna, forming a laminated structure having at least two layers.

21. The chip card module of claim 20 further comprising a second antenna disposed on a second major surface of the antenna carrier.

22. The chip card module of claim 21 wherein said first antenna and said second antenna are metallizations formed on the respective major surfaces of the antenna carrier.

23. The chip card module of claim 20 wherein the antenna carrier is formed of a thin, flexible material having a modulus of elasticity greater than that of said metallizations.

24. The chip card module of claim 22, wherein the antenna carrier comprises a carrier strip, the carrier strip having a plurality of further antenna coils disposed thereon.
